(19) United States
(12) Patent Application Publication
(10) Pub. No.: US 2025/0350983 A1
(43) Pub. Date: Nov. 13, 2025

(54) DOWNLINK CHANNEL STATE INFORMATION REQUESTS DRIVEN BY PHYSICAL UPLINK SHARED CHANNEL LINK ADAPTATIONS

(71) Applicant: Telefonaktiebolaget LM Ericsson (publ), Stockholm (SE)

(72) Inventors: Qingchao LIU, Ottawa, Ontario (CA); Ping YU, Ottawa, Ontario (CA)

(73) Assignee: Telefonaktiebolaget LM Ericsson (publ), Stockholm (SE)

(21) Appl. No.: 18/867,439

(22) PCT Filed: Jun. 22, 2022
(86) PCT No.: PCT/IB2022/055805

§ 371 Date: Nov. 20, 2024

(51) Int. Cl. H04W 24/10; H04W 72/21

(52) U.S. Cl. CPC H04W 24/10; H04W 72/21

(57) ABSTRACT

A network node configured to communicate with a wireless device (WD) is described. The network node includes processing circuitry and a radio interface in communication with the processing circuitry. The processing circuitry is configured to determine at least one component carrier (CC) to be included in a report based on at least one of an information carrying capacity (ICC) and a table; and determine a report request including at least the determined at least one CC. The radio interface is configured to transmit the report request to the WD. Other apparatuses, methods, and system are also described.

### TECHNICAL FIELD

The present disclosure relates to wireless communications, and in particular, to determination of channel state information report requests.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs.

NR downlink (DL) carrier aggregation (CA) allows a WD to increase its DL throughput by aggregating several carriers for DL data transmission. To make effective use of activated DL carriers, DL link adaptations on each carrier are used to ensure the coding rate and beamforming are the best fit (e.g., a fit) for radio channel conditions.

The DL link adaptations rely (e.g., heavily rely) on WD channel state information (CSI) reports on each DL carrier, which can be configured as periodic, semi-persistent, and/or aperiodic. Periodic or semi-persistent CSI reports blindly require (i.e., use) constant periodic UL resource occupation which may take too many resources (i.e., resources greater than a predetermined threshold), thereby being impractical for NR systems (e.g., when many active users are actively using the networks, users using CA, etc.). Configuration of aperiodic CSI (aCSI) reports may be used more frequently (than periodic or semi-persistent CSI reports) on NR systems. The aCSI may be triggered by CSI requests from the network node (e.g., gNB) as part of an uplink (UL) grant based on DL transmission demands and/or active carrier component (CC) status.

A WD can be configured with multiple trigger states (e.g., multiple aCSI trigger states), each as single or a set of specified CCs to be reported in one CSI report. The number of CCs under each trigger state, e.g., using the current 3GPP specifications, cannot exceed a capability range of the WD (e.g., set by a parameter such as simultaneousCSI-ReportsAllCC).

To adapt WD DL radio frequency (RF) conditions, a network node (e.g., gNB) may use (e.g., request, get, etc.) as frequent CSI reports on all active CCs as possible. More up-to-date DL channel conditions measured by the WD may help (i.e., lead to) more effective DL data transmissions with more adapted coding rates and accurate beams at every carrier.

However, the network node may not be able to ask for (i.e., request) a CSI report including all active component carriers CCs, e.g., in one iteration, for one or more of the following reasons:
Requesting aCSI reports uses physical uplink shared channel (PUSCH) resources which may be competed for by all the connected WDs, e.g., at a special cell (SpCell). A scheduler may allocate resources based on various priority rules and end up with the resources arranged to the WD for aCSI reports that may not have enough radio resources to accommodate a report including all CCs, especially when RF conditions are poor (i.e., below a predetermined threshold).
The resources for aCSI reports can also be limited due to WD power headroom especially when RF conditions are poor.
UL resources may be shared among multiple WDs, thereby limiting the resources (e.g., in the quantity of resource blocks (RBs)) that can be allocated to each WD.
A minimum UL throughput and a uplink control information (UCI) decoding performance must be met to get UL coverage and DL throughput that exceeds a predetermined threshold for a WD.

Further, when UL RF conditions associated with a WD are poor, PUSCH resource is limited. Accordingly, blindly pursuing a large number of CA CCs (i.e., exceeding a predetermined threshold) may result in an exceeded coding rate, which may cause the aCSI report to fail on decoding at the receiving side (e.g., the network node side).

In addition, to avoid possible high coding rate, a UL scheduler may provide a set of predetermined RF conditions (e.g., signal to noise and interference ratio (SINR) thresholds under minimal PUSCH physical resource blocks (PRBs)) for the allowed CC numbers to be involved in an aCSI report. When the set of predetermined RF conditions is the sole factor considered, the set of predetermined RF conditions may be set as conservative to avoid failure under predetermined situations (e.g., a worst situation scenario). One drawback of this solution is that under multiple situations, only a subset of the active CCs is used without considering the available resource elements (REs) that can be used for the aCSI report allocation. Further, there is a possibility that available PUSCH resources within a WD power headroom limit could take more CCs for the aCSI report.

Reporting a single or a subset of CCs at each aCSI report may result in either more frequent aCSI requests (which consume more PDCCH resources for UL grants and PUSCH resources for the reports) or extending a report period for each CC DL channel condition, which may result in inefficiency of DL link adaptation such as when the WD is moving. In addition, trying different CCs in the aCSI during PUSCH link adaptation may lead to increased processing power consumption for the link adaptation.

In other words, typical selection of CCs included in aCSI reports cannot adequately adapt to different conditions such as dynamic changes in RF conditions.

### SUMMARY

Some embodiments advantageously provide methods, systems, and apparatuses for determining report requests (e.g., DL CSI requests) driven by link adaptations (e.g., PUSCH link adaptations). For example, when CA is used and an aCSI report is requested, at least one CC (e.g., active CCs) may be determined. The at least one CC may be a maximum (i.e., a maximized) number/quantity of active CCs included in one CSI report (e.g., aCSI report).

In some embodiments, CCs are selected (e.g., a quantity of CCs) for aCSI reports by:
Estimating CCs for aCSI reports with considering usable resources before PUSCH link adaptation; and/or
Using a simple look-up table based on the simulation for CCs selection.

The following nonlimiting factors may be considered to determine the maximum allowed CCs to be included in the aCSI report:
gNB measured SINR during a previous PUSCH reception; and/or
available PUSCH PRBs and/or within a WD power headroom.

In some other embodiments, a table may be used to determine the CCs, where the table may include and/or be based on:
Maximum allowed hybrid automatic repeat request acknowledgement (HARQ-ACK) bits by using a dynamic HARQ-ACK codebook which may be based on a PUSCH RF condition included as UCI on PUSCH. UCI may include aCSI and/or HARQ-ACK; and/or
Minimal UL data throughput under poor PUSCH channel condition for keeping WD alive in (i.e., connected to) the network.

The table search may result in selecting the maximum number of allowed CCs to be involved in the PUSCH before PUSCH link adaptation start. Further, the corresponding CSI trigger state can be determined for the CSI request.

In one embodiment, a network node (e.g., a scheduler of the network node) may be configured to maximize active CCs (e.g., quantity of active CCs) within one aCSI based on PUSCH RF condition(s) and/or available PUSCH resources, e.g., without increasing PUSCH link adaptation processing power.

In another embodiment, aggressive/conservative approaches to link adaptation may be avoided, and a minimum UL throughput may be met, e.g., to avoid WD drop with transmission control protocol (TCP) traffic and/or UCI decoding performance.

In some embodiments, link adaptation may be sped up (i.e., time associated with performing link adaptation shortened) using one or more tables such as pre-simulated tables.

In some other embodiments, having more CCs (when compared to typical CCs reporting) to be simultaneously reported within one aCSI report may allow a DL scheduler (e.g., a scheduler of the network node) to have more effective DL link adaptations. Further, consolidating as many active CCs as possible (i.e., a maximized quantity of active CCs as described herein) in one aCSI report may save physical downlink control channel (PDCCH) and/or PUSCH resources when compared to the use a subset of active CCs in multiple aCSI reports.

In one aspect of the present disclosure, a network node configured to communicate with a wireless device (WD) is described. The network node includes processing circuitry configured to determine at least one component carrier (CC) to be included in a report based on at least one of an information carrying capacity (ICC) and a table; and determine a report request including at least the determined at least one CC. The network node also includes a radio interface in communication with the processing circuitry, where the radio interface is configured to transmit the report request to the WD.

In some embodiments, the radio interface is further configured to receive the report from the WD via physical uplink shared channel (PUSCH); and transmit data to the WD based at least in part on the received report.

In some other embodiments, the processing circuitry is further configured to determine a plurality of request options. Each request option of the plurality of request options includes at least one CC and corresponds to one trigger state index. Each request option includes a different quantity of CCs. The plurality of request options is provided by a downlink scheduler to an uplink scheduler of the network node. The processing circuitry is further configured to select one request option from the determined plurality of request options to maximize the quantity of CCs based on a physical uplink shared channel, PUSCH, radio frequency, RF, condition and available physical resource blocks, PRBs. The selected one request option is usable to determine at least one CC to be included in the report and the report request; and/or the report is usable for determining a link adaptation.

In one embodiment, the processing circuitry is further configured to determine an uplink channel condition and the ICC based at least in part on an uplink transmission. The uplink channel condition includes a signal to interference noise ratio (SINR) per physical resource block (PRB). The ICC is in units of PRBs.

In another embodiment, the processing circuitry is further configured to determine at least one uplink control information (UCI) bit based on at least one of: at least one CSI trigger state; computed aperiodic channel state information (aCSI) bits associated to activated CCs configured under one selected CSI trigger state; and at least one applied hybrid automatic repeat request (HARQ) bit.

In some embodiments, the processing circuitry is further configured to determine available PRBs usable for UCI transmission upon link adaptation and select one trigger state based at least in part on the determined available PRBs. The selected one trigger state indicates the at least one CC to be included in the report.

In some other embodiments, the processing circuitry is further configured to determine the table based on at least one of a radio frequency (RF) condition and a modulation and coding scheme (MCS) usable for PUSCH resource allocation.

In one embodiment, the table includes a signal to noise ratio, SNR, impact in an SNR delta compared to a CSI without HARQ bits.

In another embodiment, the table includes another SNR impact in another SNR delta compared to UCI including HARQ bits.

In some embodiments, the report is an aperiodic channel state information (aCSI) report.

In another aspect, a method in a network node configured to communicate with a wireless device (WD) is described. The method includes determining at least one component carrier (CC) to be included in a report based on at least one of an information carrying capacity (ICC) and a table; determining a report request including at least the determined at least one CC; and transmitting the report request to the WD.

In some embodiments, the method further includes receiving the report from the WD via physical uplink shared channel (PUSCH) and transmitting data to the WD based at least in part on the received report.

In some other embodiments, the method further includes determining a plurality of request options. Each request option of the plurality of request options includes at least one CC and corresponds to one trigger state index. Each request option includes a different quantity of CCs. The plurality of request options is provided by a downlink scheduler to an uplink scheduler of the network node. The method further includes selecting one request option from the determined plurality of request options to maximize the quantity of CCs based on a physical uplink shared channel, PUSCH, radio frequency, RF, condition and available physical resource blocks, PRBs. The selected one request option is usable to determine the at least one CC to be included in the report and the report request; and/or the report is usable for determining a link adaptation.

In one embodiment, the method further includes determining an uplink channel condition and the ICC based at least in part on an uplink transmission, where the uplink channel condition includes a signal to interference noise ratio (SINR) per physical resource block (PRB). The ICC is in units of PRBs.

In another embodiment, the method further includes determining at least one uplink control information (UCI) bit based on at least one of: at least one CSI trigger state; computed aperiodic channel state information (aCSI) bits associated to activated CCs configured under one selected CSI trigger state; and at least one applied hybrid automatic repeat request (HARQ) bit.

In some embodiments, the method further includes determining available PRBs usable for UCI transmission upon link adaptation and selecting one trigger state based at least in part on the determined available PRBs. The selected one trigger state indicating the at least one CC to be included in the report.

In some other embodiments, the table is determined based on at least one of a radio frequency (RF) condition and a modulation and coding scheme (MCS) usable for PUSCH resource allocation.

In one embodiment, the table includes a signal to noise ratio (SNR) impact in an SNR delta compared to a CSI without HARQ bits.

In another embodiment, the table includes another SNR impact in another SNR delta compared to UCI including HARQ bits.

In some embodiments, the report is an aperiodic channel state information (aCSI) report.

In one aspect, a wireless device (WD) configured to communicate with a network node is described. The WD includes processing circuitry (84) configured to determine a report based at least on a report request. The report request includes at least one component carrier (CC). The at least one CC is based on at least one of an information carrying capacity (ICC) and a table. The WD further includes a radio interface in communication with the processing circuitry, where the radio interface is configured to transmit the report to the network node.

In some embodiments, the radio interface is further configured to at least one of receive the report request from the network node; transmit the report to the network node via physical uplink shared channel, PUSCH; and receive data from the network node based at least in part on the transmitted report.

In some other embodiments, the report is usable for determining a link adaptation.

In one embodiment, the at least one CC is further based on an uplink channel condition. The ICC is based at least in part on an uplink transmission. The uplink channel condition includes a signal to interference noise ratio (SINR) per physical resource block (PRB), and the ICC is in units of PRBs.

In another embodiment, the at least one CC is further based on at least one uplink control information (UCI). The at least one UCI being based on at least one of: at least one CSI trigger state; computed aperiodic channel state information (aCSI) bits associated to activated CCs configured under one selected CSI trigger state; and at least one applied hybrid automatic repeat request (HARQ) bit.

In some embodiments, the processing circuitry is further configured to determine the least one CC based on one trigger state, where the one trigger state is based at least in part on available PRBs.

In some other embodiments, the table is based on at least one of a radio frequency (RF) condition and a modulation and coding scheme (MCS) usable for PUSCH resource allocation.

In one embodiment, the table includes a signal to noise ratio (SNR) impact in an SNR delta compared to a CSI without HARQ bits.

In another embodiment, the table includes another SNR impact in another SNR delta compared to UCI including HARQ bits.

In some embodiments, the report is an aperiodic channel state information (aCSI) report.

In another aspect, a method in a wireless device (WD) configured to communicate with a network node is described. The method includes determining a report based at least on a report request. The report request includes at least one component carrier (CC). The at least one CC is based on at least one of an information carrying capacity (ICC) and a table. The method further includes transmitting the report to the network node.

In some embodiments, the method further includes at least one of: receiving the report request from the network node; transmitting the report to the network node via physical uplink shared channel (PUSCH); and receiving data from the network node based at least in part on the transmitted report.

In some other embodiments, the report is usable for determining a link adaptation.

In one embodiment, the at least one CC is further based on an uplink channel condition. The ICC is based at least in part on an uplink transmission. The uplink channel condition includes a signal to interference noise ratio (SINR) per physical resource block (PRB), and the ICC is in units of PRBs.

In another embodiment, the at least one CC is further based on at least one uplink control information (UCI), where the at least one UCI is based on at least one of: at least one CSI trigger state; computed aperiodic channel state information (aCSI) bits associated to activated CCs configured under one selected CSI trigger state; and at least one applied hybrid automatic repeat request (HARQ) bit.

In some embodiments, the method further includes determining the least one CC based on one trigger state, the one trigger state being based at least in part on available PRBs.

In some other embodiments, the table is based on at least one of a radio frequency (RF) condition and a modulation and coding scheme (MCS) usable for PUSCH resource allocation.

In one embodiment, the table includes a signal to noise ratio, SNR, impact in an SNR delta compared to a CSI without HARQ bits.

In another embodiment, the table includes another SNR impact in another SNR delta compared to UCI including HARQ bits.

In some embodiments, the report is an aperiodic channel state information (aCSI) report.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an exemplary network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating exemplary methods implemented in a communication system including a host computer, a network node and a wireless device for executing a client application at a wireless device according to some embodiments of the present disclosure;

FIG. 4 is a flowchart illustrating exemplary methods implemented in a communication system including a host computer, a network node and a wireless device for receiving user data at a wireless device according to some embodiments of the present disclosure;

FIG. 5 is a flowchart illustrating exemplary methods implemented in a communication system including a host computer, a network node and a wireless device for receiving user data from the wireless device at a host computer according to some embodiments of the present disclosure;

FIG. 6 is a flowchart illustrating exemplary methods implemented in a communication system including a host computer, a network node and a wireless device for receiving user data at a host computer according to some embodiments of the present disclosure;

FIG. 7 is a flowchart of an exemplary process in a network node according to some embodiments of the present disclosure;

FIG. 8 is a flowchart of an exemplary process in a wireless device according to some embodiments of the present;

FIG. 9 is an example block sequence diagram for determining a request;

FIG. 10 is an example graph of UL shared channel throughput according to some embodiments of the present disclosure;

FIG. 11 is an example graph of UL shared channel normalized throughput according to some embodiments of the present disclosure;

FIG. 12 is an example graph of UL shared channel BLER according to some embodiments of the present disclosure;

FIG. 13 is another example graph of UL shared channel BLER according to some embodiments of the present disclosure;

FIG. 14 is an example graph of UL shared channel normalized throughput versus two CC CSI according to some embodiments of the present disclosure;

FIG. 15 is an example graph of UL shared channel throughput versus two CC CSI according to some embodiments of the present disclosure;

FIG. 16 is an example table determined based on RF condition and/or MCS according to some embodiments of the present disclosure; and

FIG. 17 is another example table determined based on RF condition and/or MCS according to some embodiments of the present disclosure.

### DETAILED DESCRIPTION

Before describing in detail exemplary embodiments, it is noted that the embodiments reside primarily in combinations of apparatus components and processing steps related to determining report requests (e.g., DL CSI requests) driven by link adaptations (e.g., PUSCH link adaptations). Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may comprise one or more scheduler configured to schedule at least communication/signals between the network node and the WD. The scheduler may be a DL scheduler configured to schedule downlink communication/signals. The scheduler may also be a UL scheduler configured to schedule uplink communication/signals. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

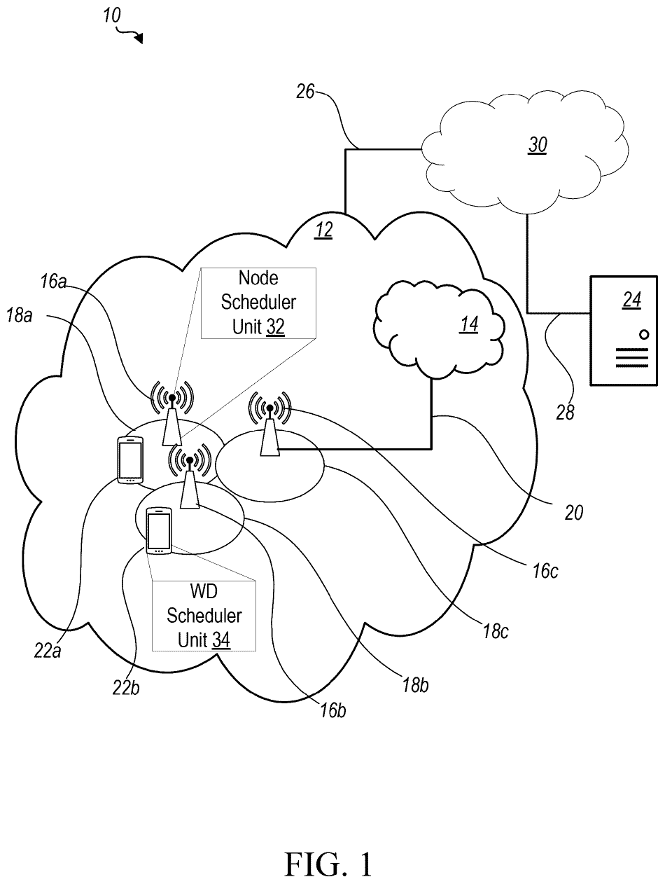

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a node scheduler unit 32 which is configured to perform any step and/or task and/or process and/or method and/or feature described in the present disclosure, e.g., determine at least one component carrier (CC) to be included in a report based on at least one of an information carrying capacity (ICC) and a table and determine a report request including at least the determined at least one CC. A wireless device 22 is configured to include a WD scheduler unit 34 which is configured to perform any step and/or task and/or process and/or method and/or feature described in the present disclosure, e.g., determine a report based at least on a report request, where the report request includes at least one CC, and the at least one CC is based on at least one of an ICC and a table.

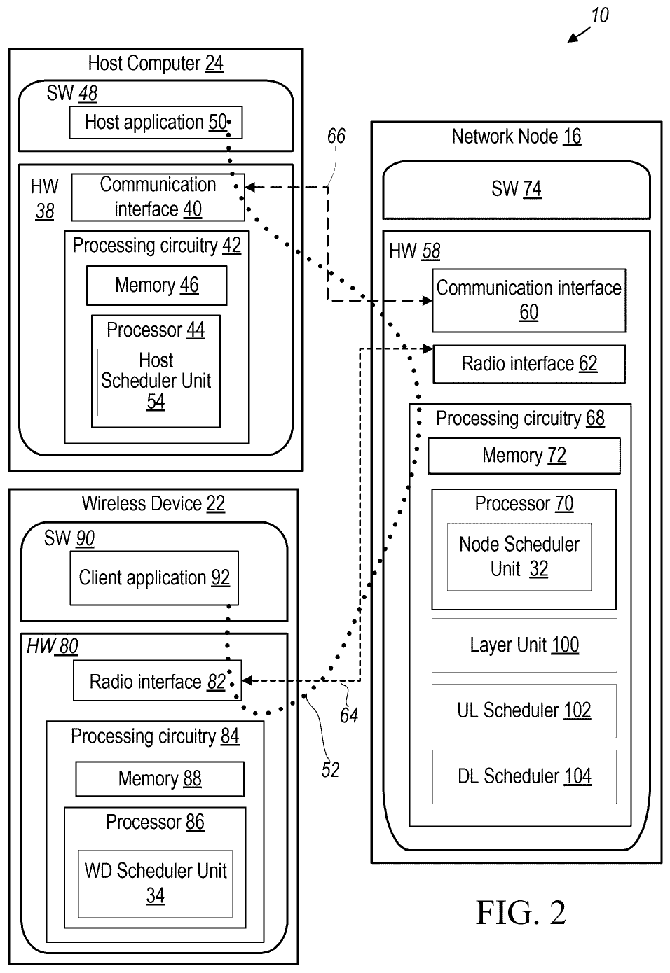

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include a host scheduler unit 54 configured to enable the service provider to perform any step and/or task and/or process and/or method and/or feature described in the present disclosure, e.g., observe/monitor/control/transmit to/receive from the network node 16 and/or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include node scheduler unit 32 which is configured to perform any step and/or task and/or process and/or method and/or feature described in the present disclosure, e.g., determine at least one component carrier (CC) to be included in a report based on at least one of an information carrying capacity (ICC) and a table and determine a report request including at least the determined at least one CC.

Network node 16 (and/or processing circuitry 68) may also include layer unit 100 and/or UL scheduler 102 and/or DL scheduler. Any one of the layer unit 100 and/or UL scheduler 102 and/or DL scheduler may be part of one or more components of network node 16 such as communication interface 60 and/o radio interface 62 and/or node scheduler unit 32. Layer unit 100 may be configured to perform to perform any step and/or task and/or process and/or method and/or feature associated with one or more layer functions, e.g., UL physical layer (ULPHY), such as performing channel measurements and/or reporting channel conditions to other components of network node 16. UL scheduler 102 may be configured to perform to perform any step and/or task and/or process and/or method and/or feature associated with uplink scheduling, e.g., determining at least one component carrier (CC) to be included in a report and/or determine a report request including at least the determined at least one CC and/or receive UL RF measurements and/or CSI requests and/or transmit CSI requests. DL scheduler 104 may be configured to perform any step and/or task and/or process and/or method and/or feature associated with downlink scheduling, e.g., transmit CSI requests and/or receive CSI reports and/or transmit DL data such as via one or more physical channels.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a WD scheduler unit 34 which is configured to perform any step and/or task and/or process and/or method and/or feature described in the present disclosure, e.g., determine a report based at least on a report request, where the report request includes at least one CC, and the at least one CC is based on at least one of an ICC and a table. Although not shown, WD 22 may include one or more additional units similar to layer unit 100 and/or UL scheduler 102 and/or DL scheduler 104 of network node 16.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as node scheduler unit 32, and WD scheduler unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

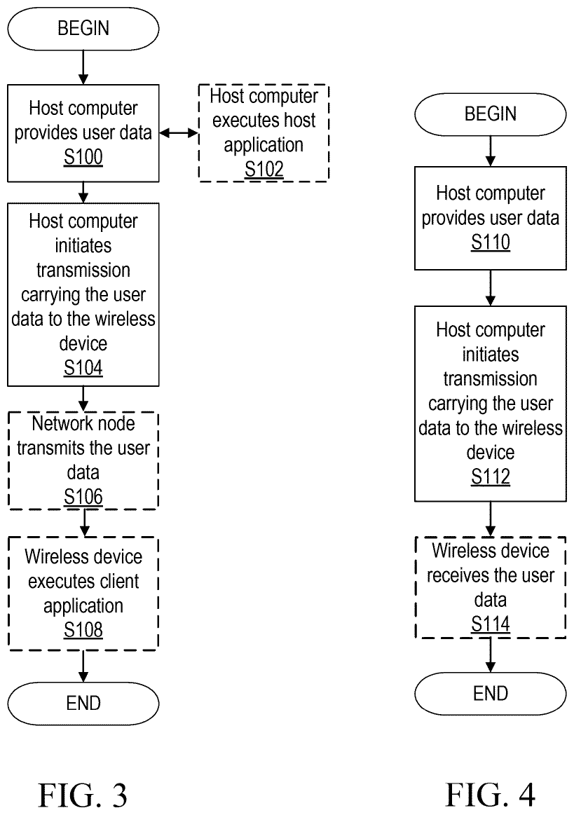

FIG. 3 is a flowchart illustrating an exemplary method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an exemplary method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

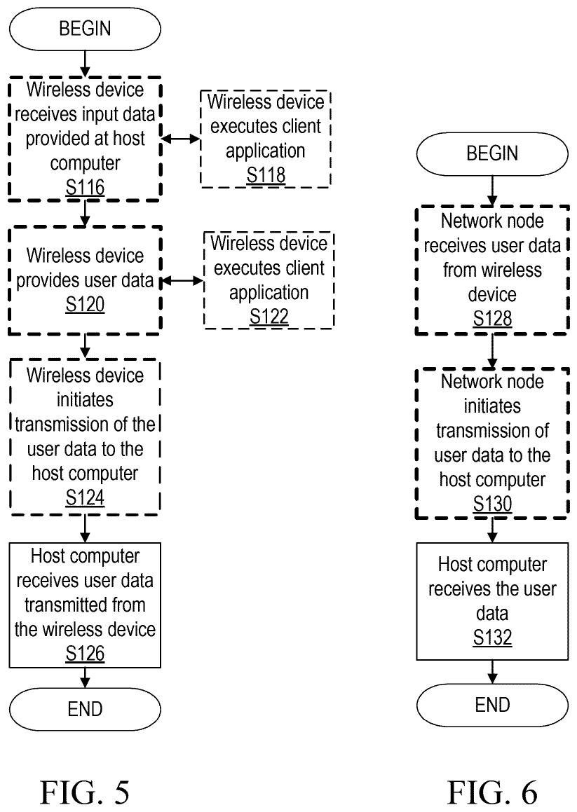

FIG. 5 is a flowchart illustrating an exemplary method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an exemplary method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

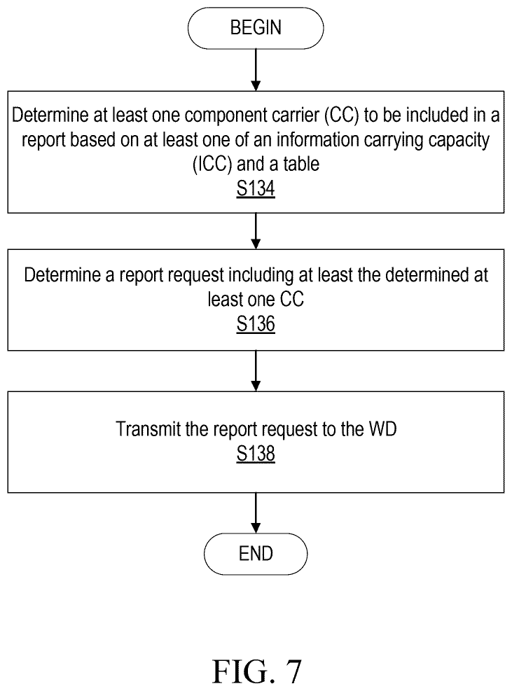

FIG. 7 is a flowchart of an exemplary process (i.e., method) in a network node 16. One or more blocks described herein may be performed by one or more elements of network node 16 such as by one or more of processing circuitry 68 (including the node scheduler unit 32), processor 70, radio interface 62 and/or communication interface 60. Network node 16 such as via processing circuitry 68 and/or processor 70 and/or radio interface 62 and/or communication interface 60 is configured to determine (Block S134) at least one component carrier (CC) to be included in a report based on at least one of an information carrying capacity (ICC) and a table; determine (Block S136) a report request including at least the determined at least one CC; and transmit (Block S138) the report request to the WD 22.

In some embodiments, the method further includes receiving the report from the WD 22 via physical uplink shared channel (PUSCH) and transmitting data to the WD 22 based at least in part on the received report.

In some other embodiments, the method further includes determining a plurality of request options. Each request option of the plurality of request options includes at least one CC and corresponds to one trigger state index. Each request option includes a different quantity of CCs. The plurality of options is provided by a downlink scheduler to an uplink scheduler of the network node 16. The method further includes selecting one request option from the determined plurality of request options to maximize the quantity of CCs based on a physical uplink shared channel, PUSCH, radio frequency, RF, condition and available physical resource blocks, PRBs. The selected one request option is usable to determine the at least one CC to be included in the report and the report request; and/or the report is usable for determining a link adaptation.

In one embodiment, the method further includes determining an uplink channel condition and the ICC based at least in part on an uplink transmission, where the uplink channel condition includes a signal to interference noise ratio (SINR) per physical resource block (PRB). The ICC is in units of PRBs.

In another embodiment, the method further includes determining at least one uplink control information (UCI) bit based on at least one of: at least one CSI trigger state; computed aperiodic channel state information (aCSI) bits associated to activated CCs configured under one selected CSI trigger state; and at least one applied hybrid automatic repeat request (HARQ) bit.

In some embodiments, the method further includes determining available PRBs usable for UCI transmission upon link adaptation and selecting one trigger state based at least in part on the determined available PRBs. The selected one trigger state indicating the at least one CC to be included in the report.

In some other embodiments, the table is determined based on at least one of a radio frequency (RF) condition and a modulation and coding scheme (MCS) usable for PUSCH resource allocation.

In one embodiment, the table includes a signal to noise ratio (SNR) impact in an SNR delta compared to a CSI without HARQ bits.

In another embodiment, the table includes another SNR impact in another SNR delta compared to UCI including HARQ bits.

In some embodiments, the report is an aperiodic channel state information (aCSI) report.

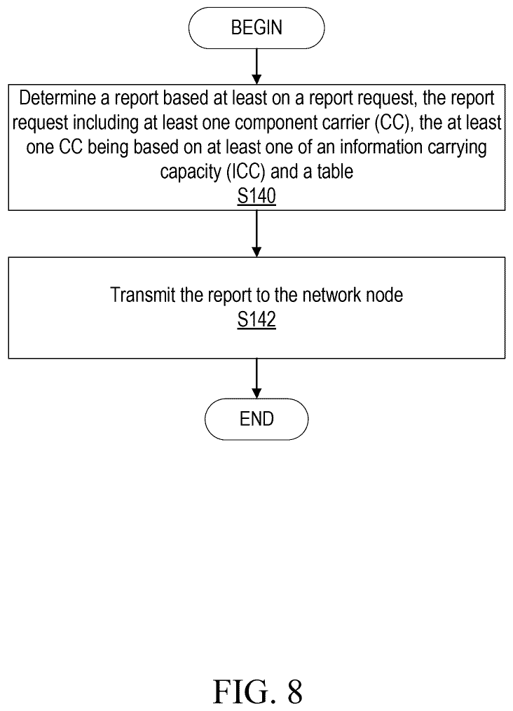

FIG. 8 is a flowchart of an exemplary process in a wireless device 22. One or more blocks described herein may be performed by one or more elements of wireless device 22 such as by one or more of processing circuitry 84 (including the WD scheduler unit 34), processor 86, radio interface 82 and/or communication interface 60. Wireless device 22 such as via processing circuitry 84 and/or processor 86 and/or radio interface 82 is configured to determine (Block S140) a report based at least on a report request, where the report request includes at least one component carrier (CC), and the at least one CC is based on at least one of an information carrying capacity (ICC) and a table; and transmit (Block S142) the report to the network node 16.

In some embodiments, the method further includes to at least one of: receiving the report request from the network node 16; transmitting the report to the network node 16 via physical uplink shared channel (PUSCH); and receiving data from the network node 16 based at least in part on the transmitted report.

In some other embodiments, the report is usable for determining a link adaptation.

In one embodiment, the at least one CC is further based on an uplink channel condition. The ICC is based at least in part on an uplink transmission. The uplink channel condition includes a signal to interference noise ratio (SINR) per physical resource block (PRB), and the ICC is in units of PRBs.

In another embodiment, the at least one CC is further based on at least one uplink control information (UCI), where the at least one UCI is based on at least one of: at least one CSI trigger state; computed aperiodic channel state information (aCSI) bits associated to activated CCs configured under one selected CSI trigger state; and at least one applied hybrid automatic repeat request (HARQ) bit.

In some embodiments, the method further includes determining the least one CC based on one trigger state, the one trigger state being based at least in part on available PRBs.

In some other embodiments, the table is based on at least one of a radio frequency (RF) condition and a modulation and coding scheme (MCS) usable for PUSCH resource allocation.

In one embodiment, the table includes a signal to noise ratio, SNR, impact in an SNR delta compared to a CSI without HARQ bits.

In another embodiment, the table includes another SNR impact in another SNR delta compared to UCI including HARQ bits.

In some embodiments, the report is an aperiodic channel state information (aCSI) report.

Having described the general process flow of arrangements of the disclosure and having provided examples of hardware and software arrangements for implementing the processes and functions of the disclosure, the sections below provide details and examples of arrangements for determining report requests (e.g., DL CSI requests) driven by link adaptations (e.g., PUSCH link adaptations).

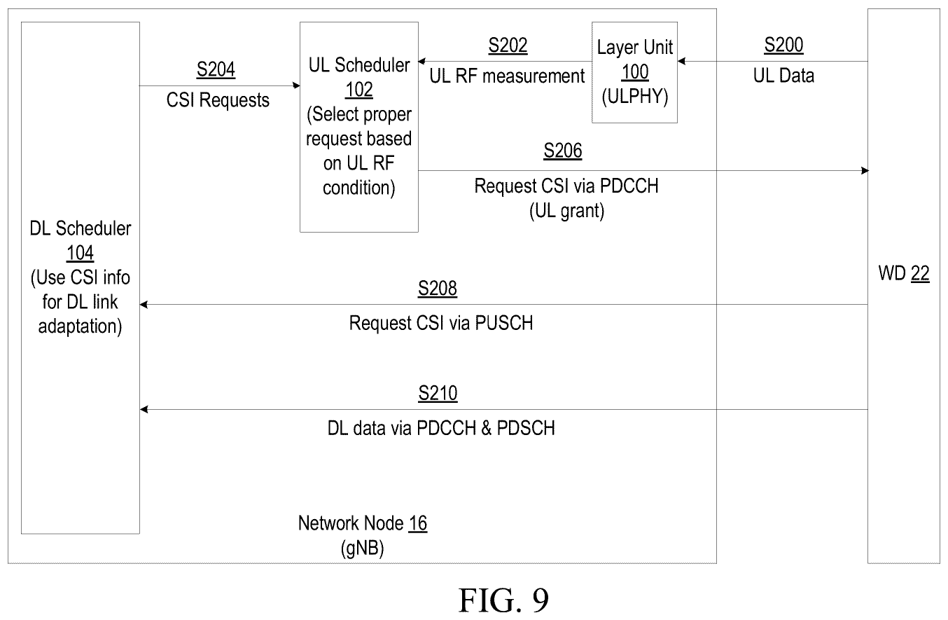

FIG. 9 shows an example block sequence diagram for determining a request, e.g., aCSI request, that is transmittable to WD 22, and where WD 22 may report CSI measurements on requested carriers. The example block sequence includes one ore more of the following steps:

S200: When a WD 22 sends, e.g., via radio interface 82, UL data, layer unit 100 (e.g., a gNB ULPHY) performs PUSCH channel measurements and/or reports PUSCH channel condition(s) to UL scheduler 102.

S202: DL scheduler 104 asks (i.e., requests) UL scheduler 102 to send an aperiodic CSI request to the CA WD 22 with a set of options, where each option includes a unique number of activated CCs.

S204: UL scheduler chooses (i.e., determines, selects) a number of CCs (i.e., CCs, a quantity of CCs) to be included in the request based on the PUSCH condition and usable PRBs.

S206: The request (e.g., aCSI request) is sent to WD 22 (e.g., CA WD) via PDCCH, e.g., along with DL HARQ-ACK bits and/or UL data.

S208: WD 22 reports (i.e., determines, transmits, etc.) the measured CSI conditions based on the request.

S210: DL scheduler 104 may be configured for and/or perform link adaptation (e.g., PDCCH and PDSCH link adaptation) for DL data transmission.

In some embodiments, by performing at least S204, an effective way is provided to determine the number of CA carrier components involved before PUSCH link adaptation starts. Step S204 may be referred to as a pre-selection step, which may simplify link adaptation, e.g., PUSCH link adaptation, such as by avoiding the involvement of multiple mandatory bits.

Steps S200-S210 are not limited to being performed in the order shown in FIG. 9 and may be performed in any order. Further, not all steps S200-S210 need to be performed.

In addition, any one of steps S200-S210 described above and/or other steps described herein may be performed by the corresponding component of WD 22 (e.g., radio interface 82) and/or network node 16 (e.g., communication interface 60, radio interface 62, processing circuitry 68, node scheduler unit 32, layer unit 100, UL scheduler 102, DL scheduler 104, etc.). Further, in some embodiments, any of the steps performed by layer unit 100, UL scheduler 102, DL scheduler 104 may be performed by processing circuitry 68 and/or radio interface 62.

In the following nonlimiting embodiments, SINR may refer to SINR related to PUSCH measurements, and SNR may refer to WD transmission (Tx) SNR at the gNB reception (Rx) antenna port (i.e., Rx antenna port of the network node 16), where pathloss may already be reflected.

Embodiment 1: Selecting a number/quantity of carrier components (i.e., selecting CCs, selecting at least one CC to be included in) in one aCSI report based on Information Carrying Capacity (ICC)
1) UL channel condition evaluation and ICC decision.
   Upon receiving a set of UL data transmission, UL physical layer (i.e., layer unit 100) measures wideband PUSCH SINR and interference and noise (IpN) per PUSCH resource block (RB) that carries WD UL data.
   The SINR and IpN measurement may be reported to UL scheduler 102. Together with the WD power headroom report (e.g., pathloss), the SINR per PRB can be evaluated.
   Estimate (e.g., by UL scheduler 102) SINR/PRB->ICC in units of PRB->number of raw bits/PRB noOfBits_{prb}. In other words, SINR per PRB is determined to determine ICC in units of PRB. ICC in units of PRB may be used to determine a quantity of raw bits per PRB.
2) Determine (e.g., by UL scheduler 102) a UCI bits estimation.
   DL scheduler 104 selects a subset of CSI trigger states:
      Each entry (i.e., of the subset of CSI trigger states) contains a specific number (i.e., quantity) of active carriers for the report request. The number may start from high to low, where the lowest is 1. Other combinations may be configured as well.
      Report size may be based in part on the number of carriers, e.g., the more carriers are involved in one report, the longer the report size may be.
   Configured betaOffset_{csi_x} for CSI and Configured betaOffset_{harq} for HARQ bits:
      The parameters BetaOffsets (i.e., betaOffset_{csi_x} for CSI and Configured betaOffset_{harq} for HARQ bits) are used to ensure a desired lower UCI block error rate (BLER) target when compared to UL data, e.g., when multiplexing and transmitting UCI and UL data together.
   Go over (i.e., inspect, use, parse, etc.) each entry in the subset (associated with DL scheduler 104) of the requested CSI trigger states list and/or calculate (i.e., determine) the aCSI bits:

$$aCSI bits per CC {aCsiBits}_{cc} = aCsiPart 1 Bits * {betaOffset}_{csi 1} + aCsiPart 2 Bits * {betaOffset}_{csi 2}$$

aCsiPart1Bits <=6; aCsiPart2Bits <=11, e.g., according to some 3GPP specifications. Note: This may be considered a nonlimiting example for a wideband channel quality indicator (CQI) and wideband pre-coding matrix indicator (PMI) case. There may be subband cases with more part1 and/or part2 bits. In other words, aCsiPart1Bits and/or aCsiPart2Bits may be used, e.g., based on CSI report and/or channel state information reference signal (CSI-RS) port configuration associated with each CC.
Each requested CSI trigger state i, aCsiBits[i]=Sum of (aCsiBits_{cc}) for all involved CCs in that entry
HARQ bits may be an exact (i.e., predetermined) value if already known by the scheduling time or an estimated maxharqBits:
   maxHarqBits may be obtained based on CA configuration of WD 22 and/or further capped with HARQ bit link adaptation;
   maxHarqBits may be going with (i.e., included in) the aCSI request and/or may be fewer bits than bits going with regular UL data, e.g., K2 used here is larger; In some nonlimiting examples, K2 may refer to a number of slots (e.g., from a slot used for sending a UL grant via PDCCH to another slot used for the granted UL data transmission). For example, if a UL grant is sent at slot 7 with K2=2, the UL data is transmitted at slot 9. The minimal K2s to be used may be specified so that the WD 22 may have enough time to prepare the granted UL transmission (Tx); aCSI report may take a longer time for preparation. Accordingly, larger minimal K2s (than typical UL data transmissions) may be defined for this case. In some other nonlimiting examples, K2 may refer to an offset between slots, such as a DL slot where downlink control information for uplink scheduling is received and the UL slot where UL data is sent on PUSCH. and/or
   Raw HARQ bit harqBits=maxHarqBits*betaOffset_{harq}.
Yield set of UCI bits associated to each requested CSI state i:

$$uciBits [ i ] = aCsiBits [ i ] + harqBits$$

3) Estimate usable PUSCH PRBs for UCI transmission.
   Upon the link adaptation for scheduling a WD 22 for the UCI over PUSCH, UL scheduler 102 may determine usable PUSCH PRBs for the WD 22, e.g., to transmit UCI and possibly still have room for UL data transmission. The usable PUSCH PRBs (PRBS_{usable}) may be minimal between available PRBs for the WD 22 to use and the PRBs that are allowed by WD power headroom.
4) Select trigger state options based on usable PUSCH PRBs
   Loop through uciBits[i], start with i=0, which contains the largest UCI bits

$$If ( {PRBs}_{usable} * {noOfBits}_{prb} ) > uciBits [ i ] * coefficient$$

Where coefficient (>=1) as additional bit room to avoid failure in PUSCH link adaptation.
   Select the associated trigger state for aCSI report request
   Else select the next i

If the above condition is not satisfied with the option containing minimal number of CCs, consider UCI only or stop the scheduling CSI for this UE on the originally desired UL target.

The following is a nonlimiting example that describes how the trigger states may be configured and how to request at least one of trigger state in the aCSI request as part of UL grant:
1) During WD connection setup with a predetermined quantity of CCs, the CSI trigger states may be configured as in Table 1 (e.g., in this nonlimiting example, 7 states are configured):

TABLE 1
Nonlimiting example trigger states configuration.

| Trigger | Trigger | | | |
|---|---|---|---|---|
| state (3CC) | state index | SCell2 | SCell1 | SpCell |
| P (i.e., SpCell) | 1 | 0 | 0 | 1 |
| S1 | 2 | 0 | 1 | 0 |
| P + S1 | 3 | 0 | 1 | 1 |
| S2 | 4 | 1 | 0 | 0 |
| P + S2 | 5 | 1 | 0 | 1 |
| S1 + S2 | 6 | 1 | 1 | 0 |
| P + S1 + S2 | 7 | 1 | 1 | 1 |

A “1” (i.e., with respect to SCells 1 and 2 and SpCell) means the CC is to be reported for the trigger state. A “0” (i.e., with respect to SCells 1 and 2 and SpCell) means the CC is not to be reported for the trigger state. For each CC, the number of bits (e.g., part1 and part2) for the report may be calculated depending on the CSI report type (channel quality indicator (CQI), rank indicator (RI), pre-coding matrix indicator (PMI)) and/or radio ports configuration.
2) When DL scheduler 104 determines that a request is to be transmitted to WD 22 for the WD 22 to report CSI for channel conditions for the configured/activated carrier components, in this nonlimiting example, DL scheduler 104 may provide up to 3 options among the above table to UL scheduler as 1CC (one out of states 1,2,4), 2CC (one out of states 3,5,6) and 3CC (7). The options are not limited to up to 3 and may be any quantity of options. The corresponding CSI bits may be the sum of the CSI bits of the selected CCs.
3) Based on UL condition(s) and number (i.e., quantity) of UL PRBs that can be used, UL scheduler 102 may determine which of the above 3 options (and/or other options) to choose for the request, e.g., by aiming for (i.e., selecting) the largest number of CCs (3) to request, based on what the condition allows. The formulas (and/or determinations of the present disclosure) and tables of the present disclosure may be used for the determination described in this nonlimiting example.

The following is another nonlimiting example that describes how the trigger states may be configured (e.g., as request options):
1) aCSI report trigger states may be configured (e.g., during WD configuration) as follows:

TABLE 2
Nonlimiting example trigger states configuration
including aCSI request selection criteria.

| | | | | | aCSI request |
|---|---|---|---|---|---|
| Trigger | Trigger | | | | selection |
| state (3CC) | state index | SCell2 | SCell1 | SpCell | criteria |
| P (i.e., SpCell) | 1 | 0 | 0 | 1 | Select if ‘state |
| | | | | | 3’ bits are too |
| | | | | | many for |
| | | | | | available |
| | | | | | RF/#PRB |
| S1 | 2 | 0 | 1 | 0 | |
| P + S1 | 3 | 0 | 1 | 1 | Select if ‘state |
| | | | | | 7’bits are too |
| | | | | | many for |
| | | | | | available |
| | | | | | RF/#PRB |
| S2 | 4 | 1 | 0 | 0 | |
| P + S2 | 5 | 1 | 0 | 1 | |
| S1 + S2 | 6 | 1 | 1 | 0 | |
| P + S1 + S2 | 7 | 1 | 1 | 1 | Select if |
| | | | | | RF/#PRB |
| | | | | | allowed |

2) In this nonlimiting example, an aCSI report may provide (i.e., transmit) one or more request options (e.g., the following 3 options) to the UL scheduler:
   Option 1: Trigger state index 7—it requests aCSI reports for 3 CCs: SpCell, SCell1, and SCell2.
   Option 2: Trigger state index 3—it requests aCSI reports for 2 CCs: SpCell, SCell1
   Option 3: Trigger state index 1—it requests aCSI reports for 1 CC: SpCell
   Each one of Options 1-3 may be referred to as a request option. The request option with the most CCs involved (e.g., Option 1 with index 7) may demand more CSI bits than Options 2, 3.
3) The UL scheduler may select one of the above request options (Options 1-3) based on its PUSCH RF condition and available PRBs, e.g., by trying first an option with the most CCs if its associated bits can be reliably transmitted. In this nonlimiting example, the order of selection is state index 7, then 3, then 1. However, other orders of selection may be used.
4) If the RF condition fails to meet a predetermined condition (e.g., bad and/or too few PUSCH PRBs are not enough to accommodate an option with a predetermined quantity of CCs (i.e., trigger state 7 or 3)), trigger state 1 with 1CC may still be a valid option to choose for sending aCSI report request(s). In other words, one (or more) CC may be selected for sending aCSI report requests(s) and/or report(s).
5) There may be conditions where 1 CC may not be used to accommodate a request. For example, when RF conditions (e.g., poor RF condition) and a few PUSCH PRBs are left (i.e., available) such as 1 or 2, the UL scheduler may schedule the request in a next scheduling opportunity.

Embodiment 2: Selecting number of carrier components (i.e., CCs, at least one CC to be included) in one aCSI based on a table (e.g., pre-generated table):

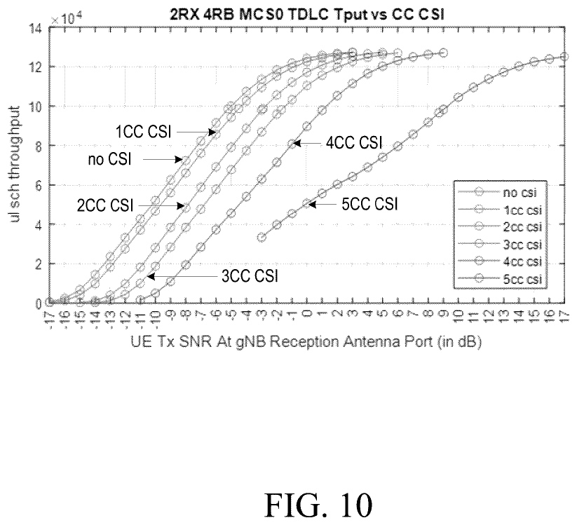

Under the same PUSCH RF condition, a larger number of PRBs allocation (if not under UE power limit) may accommodate more CCs in one aCSI report under a desired coding rate to meet the BLER target. Such relations can be built by simulation as described in the following nonlimiting examples and plotted in graphs as shown in FIGS. 10-15.

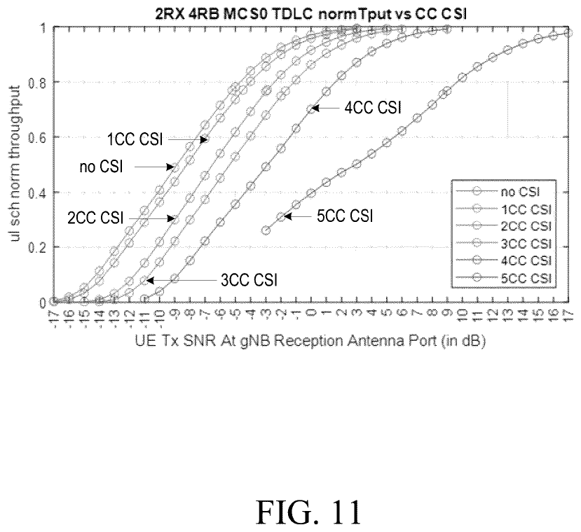

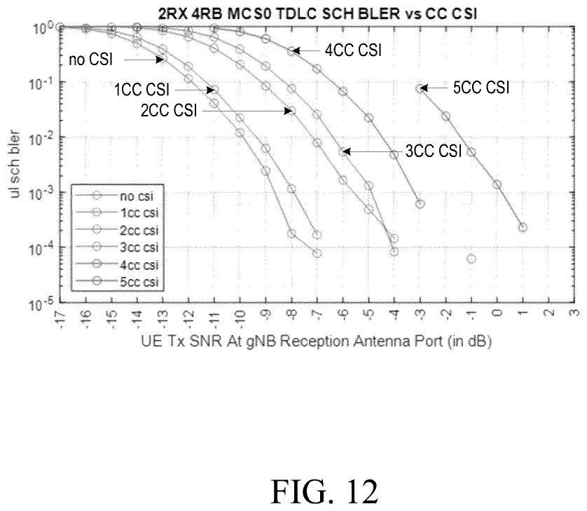

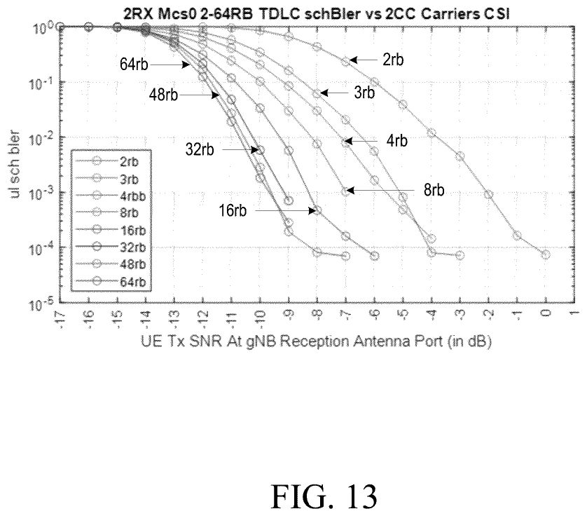

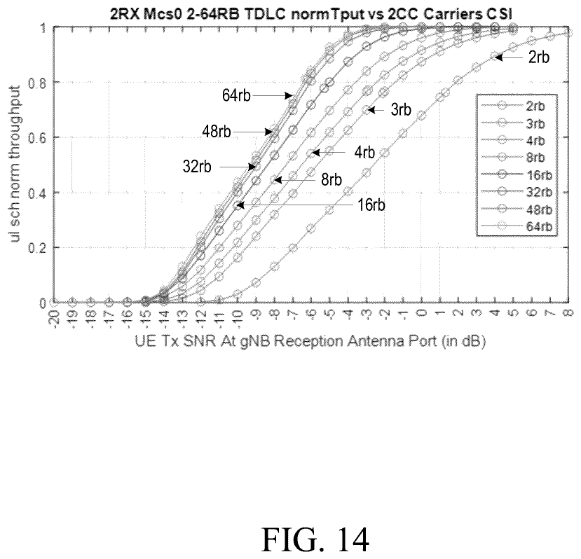

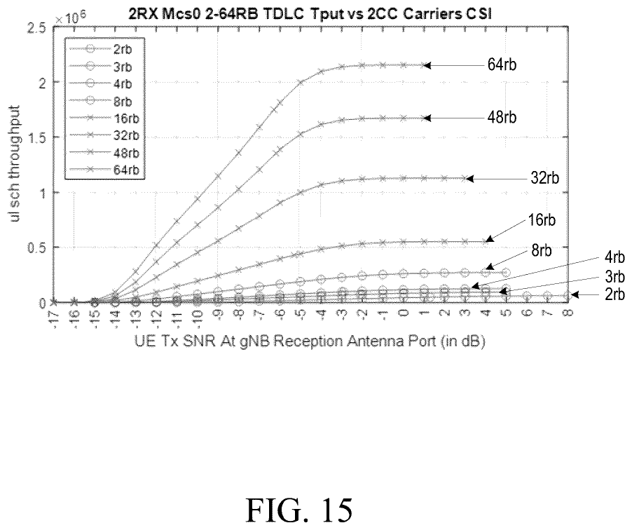

FIG. 10 shows an example graph of UL shared channel throughput versus WD (i.e., user equipment (UE)) transmission SNR at network node (e.g., gNB) reception antenna port (in dB). The example graph shows various curves, each curve corresponding to tap delay line (TDL) channel throughput having no CSI, and 1 to 5 CCs CSIs. FIG. 11 shows an example graph of UL shared channel normalized throughput versus WD transmission SNR at network node (e.g., gNB) reception antenna port (in dB). The example graph of FIG. 11 shows various curves, each curve corresponding to tap delay line (TDL) channel normalized throughput having no CSI, and 1 to 5 CCs CSIs. FIG. 12 shows an example graph of UL shared channel BLER vs WD transmission SNR at network node (e.g., gNB) reception antenna port (in dB). The example graph of FIG. 12 shows various curves, each curve corresponding to tap delay line (TDL) channel BLER having no CSI, and 1 to 5 CCs CSIs. FIG. 13 shows an example graph of UL shared channel BLER with 2 CC CSI. The example graph of FIG. 13 shows various curves, each curve corresponding to tap delay line (TDL) channel BLER having 2 RBs to 64 RBs. FIG. 14 shows an example graph of UL shared channel normal throughput with 2 CC CSI. The example graph of FIG. 14 shows various curves, each curve corresponding to UL shared channel normal throughput having 2 RBs to 64 RBs. Further, FIG. 15 shows an example graph of UL shared channel throughput with 2 CC CSI multiplexed with data on PUSCH. The example graph of FIG. 15 shows various curves, each curve corresponding to UL shared channel throughput having 2 RBs to 64 RBs.

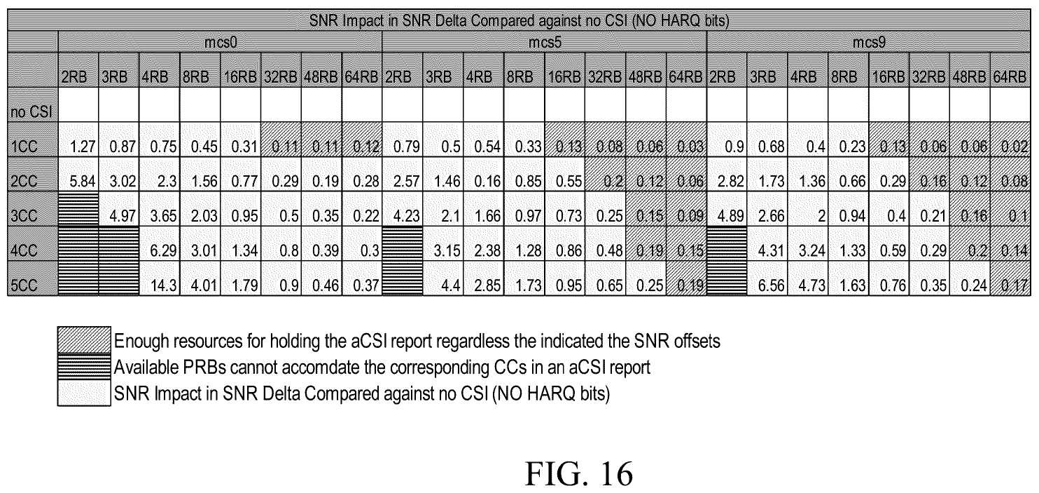

A set of tables may be built (i.e., determined) based on RF condition and/or potential MCS to be used for the PUSCH resource allocation. The number of CCs (CCs, at least one CC to be included) in the aCSI report for WD 22 may be chosen (i.e., determined) accordingly within the link adaptation loop, e.g., to save time from rate matching UCI bits and, therefore, speed up link adaptation. In some embodiments, once the number of RBs and MCS are chosen within a scheduling loop, the maximum number of CCs can be looked up (i.e., determined). The maximum number of CCs may be a chosen report option (corresponding to a trigger state choice). Further, an input to a table (i.e., MCS, quantity/number of RB, etc.) may be usable to determine CCs (i.e., a quantity of CCs). The determined CCs may refer to a maximum number of CCs for a CSI report option which is in a trigger state list. FIG. 16 shows an example table determined based on RF condition and/or potential MCS. The example table lists SNR offsets, from the PUSCH allocations without aCSI report multiplexed with data on PUSCH, required for transmitting 1 to 5 CCs CSI in the same report. This allows UL scheduler 102 to determine a desired aCSI report, based on aCSI coding rate and available PRBs, e.g., by simply searching the table, to speedup PUSCH link adaptation. In this nonlimiting example, the report may not include HARQ bits (e.g., only CSI). At least in this nonlimiting example, SNR may refer to the WD transmission (Tx) SNR at the gNB Rx antenna port (i.e., antenna port of network node 16).

In the example table, there are some cells that indicate that, in some embodiments, available PRBs cannot accommodate the corresponding number of CCs in an aCSI report with the desired coding rates. For example, for MCS0, 2RB, 3CCs cannot be accommodated by available PRBs. Further, there are some other cells that indicate that there are enough resources for holding the aCSI report, e.g., regardless the indicated the SNR offsets. For example, for MCS0, 32RB, 1CC can be accommodated, e.g., there are enough resources for holding the aCSI report with 1CC, regardless of the 0.11 indicated SNR offset. The SNR is related to WD pathloss which can be estimated based on UL measurements (reception (Rx) SINR and IpN) and/or WD power headroom reports.

Interpolation may be used between RBs and MCSs. One nonlimiting example of interpolation (MCS interpolation and RB interpolation pseudo code) and/or use of the table is as follows:

```
Top check and MCS interpolation:
    if (# of RB <= 64) {
      // look up the table
      if (mcs > 9) {
          use mcs 9 table by using some simple RB interpolation
      else if ((mcs <=9) and (mcs > 5)) {
          use mcs5 table by using some simple RB interpolation
        } else if ((mcs <=5) and (mcs > 0)) {
use mcs0 table by using some simple RB interpolation
        }
    } else {
      // there is no impact of CSI request on PUSCH
    }
RB interpolation:
    if (# of RB < 32) {
      use 16RB threshold
    } else if (# of RB < 16) {
          use 8RB threshold
    } else if (# of RB < 8) {
        use 4RB threshold
    } else if ((# of RB <=4) && (((# of RB > 1)) {
          we have the exact thresholds
  } else if (# of RB == 1) {
          Not allowed to carry CSI, must do CSI only without data
  } else {
      // there is no impact of CSI request on PUSCH, allow it always
  }
```

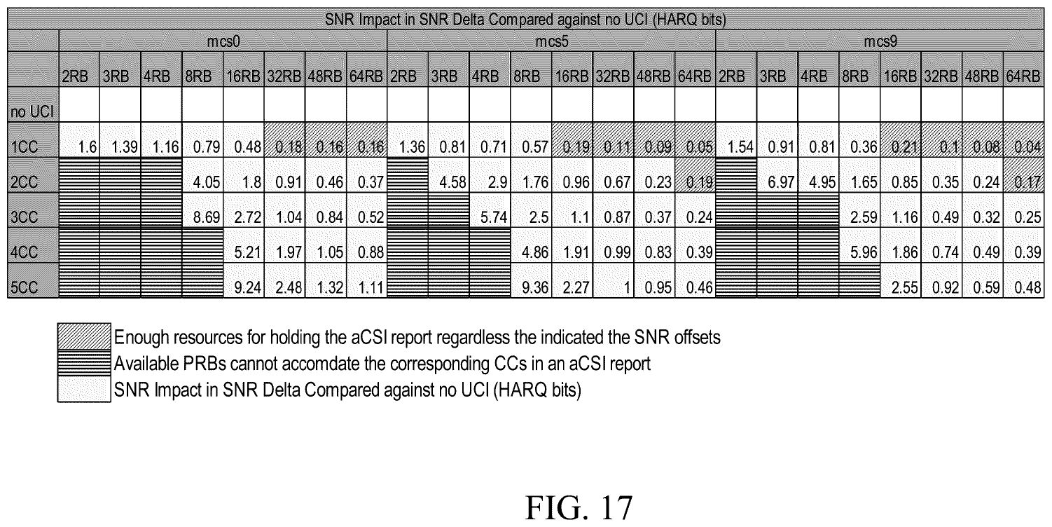

FIG. 17 shows another example table determined based on RF condition and/or potential MCS, where SNR impact in SNR delta is compared against no UCI multiplexed with data on PUSCH (e.g., including HARQ bits). If there are HARQ-ACK bits required as part of UCI on PUSCH, additional resources on PUSCH are needed (i.e., used) to transmit such HARQ-ACK bits. In a non-limiting example, UCI may include multiple parts such as 3 parts (CSI part1, CSI part2, DL HARQ).

The example table reflects such cases, i.e., where higher SNR offsets are needed with the same coding rate for asci, HARQ-ACKs, and the same available PRBs. In some embodiments, the example table of FIG. 17 is similar to the example table of FIG. 16, but CSI becomes (i.e., is associated with) UCI with HARQ bits in the table of FIG. 17 (e.g., the report may have aCSI bits and DL HARQ bits). Especially in this scenario (i.e., data multiplexed with CSI and DL HARQ bits), the number of RB may hit (i.e., reach, exceed) a limit due to various reasons (e.g., power limit, other high priority WDs, etc.). Further, UCI only on PUSCH without multiplexing data may be one choice, e.g., because DL HARQ feedback cannot be delayed or dropped.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A network node configured to communicate with a wireless device, WD, the network node comprising:
processing circuitry configured to:
determine at least one component carrier, CC, to be included in a report based on at least one of an information carrying capacity, ICC, and a table;
determine a report request including at least the determined at least one CC; and
a radio interface in communication with the processing circuitry, the radio interface configured to:
transmit the report request to the WD.

2-10. (canceled)

11. A method in a network node configured to communicate with a wireless device, WD, the method comprising:
determining at least one component carrier, CC, to be included in a report based on at least one of an information carrying capacity, ICC, and a table;
determining a report request including at least the determined at least one CC; and
transmitting the report request to the WD.

12. The method of claim 11, wherein the method further includes:
receiving the report from the WD via physical uplink shared channel, PUSCH; and
transmitting data to the WD based at least in part on the received report.

13. The method of claim 11, wherein at least one of:
the method further includes:
determining a plurality of request options, each request option of the plurality of request options including at least one CC, each request option including a different quantity of CCs and corresponding to one trigger state index, the plurality of request options being provided by a downlink scheduler to an uplink scheduler of the network node; and
selecting one request option from the determined plurality of request options to maximize the quantity of CCs based on a physical uplink shared channel, PUSCH, radio frequency, RF, condition and available physical resource blocks, PRBs, the selected one request option being usable to determine the at least one CC to be included in the report and the report request; and
the report is usable for determining a link adaptation.

14. The method of claim 11, wherein the method further includes:
determining an uplink channel condition and the ICC based at least in part on an uplink transmission, the uplink channel condition including a signal to interference noise ratio, SINR, per physical resource block, PRB, the ICC being in units of PRBs.

15. The method of claim 11, wherein the method further includes:
determining at least one uplink control information, UCI, bit based on at least one of:
at least one CSI trigger state;
computed aperiodic channel state information, aCSI, bits associated to activated CCs configured under one selected CSI trigger state; and
at least one applied hybrid automatic repeat request, HARQ, bit.

16. The method of claim 11, wherein the method further includes:
determining available PRBs usable for UCI transmission upon link adaptation; and
selecting one trigger state based at least in part on the determined available PRBs, the selected one trigger state indicating the at least one CC to be included in the report.

17. The method of claim 11, wherein the method further includes:
determining the table based on at least one of a radio frequency, RF, condition and a modulation and coding scheme, MCS, usable for PUSCH resource allocation.

18. The method of claim 17, wherein the table includes:
a signal to noise ratio, SNR, impact in an SNR delta compared to a CSI without HARQ bits.

19. The method of claim 17, wherein the table includes:
another SNR impact in another SNR delta compared to UCI including HARQ bits.

20. The method of claim 11, wherein the report is an aperiodic channel state information, aCSI, report.

21. A wireless device, WD, configured to communicate with a network node, the WD comprising:
processing circuitry configured to:
determine a report based at least on a report request, the report request including at least one component carrier, CC, the at least one CC being based on at least one of an information carrying capacity, ICC, and a table; and
a radio interface in communication with the processing circuitry, the radio interface configured to:
transmit the report to the network node.

22. The WD of claim 21, wherein the radio interface is further configured to at least one of:
receive the report request from the network node;
transmit the report to the network node via physical uplink shared channel, PUSCH; and
receive data from the network node based at least in part on the transmitted report.

23. The WD of claim 21, wherein the report is usable for determining a link adaptation.

24. The WD of claim 21, wherein the at least one CC is further based on an uplink channel condition, the ICC is based at least in part on an uplink transmission, the uplink channel condition includes a signal to interference noise ratio, SINR, per physical resource block, PRB, and the ICC is in units of PRBs.

25. The WD of claim 21, wherein the at least one CCs is further based on at least one uplink control information, UCI, the at least one UCI being based on at least one of:
at least one CSI trigger state;
computed aperiodic channel state information, aCSI, bits associated to activated CCs configured under one selected CSI trigger state; and
at least one applied hybrid automatic repeat request, HARQ, bit.

26. The WD of claim 21, wherein the processing circuitry is further configured to:
determine the least one CC based on one trigger state, the one trigger state being based at least in part on available PRBs.

27. The WD of claim 21, wherein the table is based on at least one of a radio frequency, RF, condition and a modulation and coding scheme, MCS, usable for PUSCH resource allocation.

28. The WD of claim 27, wherein the table includes:
a signal to noise ratio, SNR, impact in an SNR delta compared to a CSI without HARQ bits.

29. The WD of claim 27, wherein the table includes:
another SNR impact in another SNR delta compared to UCI including HARQ bits.

30-40. (canceled)
